(19) United States
(12) Patent Application Publication
(10) Pub. No.: US 2019/0039839 A1
(43) Pub. Date: Feb. 7, 2019

(54) METHOD AND APPARATUS FOR TRANSPORT OF A GLASS SUBSTRATE

(71) Applicant: Corning Incorporated, Corning, NY (US)

(72) Inventors: James William Brown, Painted Post, NY (US); Nicholas Dominic Cavallaro, III, Corning, NY (US); Dean George Sakona, Corning, NY (US); Jeremy Yaldo, Belle River (CA); Naiyue Zhou, Painted Post, NY (US)

(21) Appl. No.: 16/078,853

(22) PCT Filed: Feb. 23, 2017
(86) PCT No.: PCT/US17/19012

§ 371 Date: Aug. 22, 2018

Related U.S. Application Data
(60) Provisional application No. 62/301,183, filed on Feb. 29, 2016.

(51) Int. Cl. B65G 49/06; C03B 35/00

(52) U.S. Cl. CPC B65G 49/066; B65G 49/061; G02F 1/1303; C03B 35/00; B65G 49/067

(57) ABSTRACT

An apparatus and method for guiding a glass substrate positioned in a vertical orientation into a downstream process. A pair of guide arms move with the glass substrate and constrain lateral movement of an otherwise unsupported bottom edge of the glass substrate. Sensors sense a position of the glass substrate, while a controller calculates a speed of the glass substrate in a conveyance direction and positions the guide arms.

This application claims the benefit of priority under 35 U.S.C. § 119 of U.S. Provisional Application Ser. No. 62/301,183, filed on Feb. 29, 2016, the content of which is relied upon and incorporated herein by reference in its entirety.

### BACKGROUND

### Field

The present invention relates generally to methods and apparatus for transport of a glass substrate, and more particularly to restraining lateral movement of a glass sheet transported in a vertical orientation.

### Technical Background

Vertical transport of glass substrates in a glass sheet manufacturing process is advantageous at least for the reason that vertical transport takes less horizontal floor space. This is particularly beneficial for large contemporary sheet sizes, where large sheet sizes (for example approaching 10 square meters) can present great difficulty transporting through already crowded manufacturing spaces. Typically, such large glass substrates are suspended from a top edge of the glass substrate, wherein the weight of the glass substrate is sufficiently great that the glass substrate is not prone to large lateral swings in position, or sufficiently stiff that they are not overly prone to buckling. However, as sheet thicknesses decrease, particularly for glass substrates destined for the display industry, maintaining a stable orientation of the glass substrate during vertical transport is difficult.

### SUMMARY

The present disclosure describes apparatus and methods for stably transporting a vertically oriented glass substrate.

Specifically, the present disclosure describes apparatus and methods that employ guide arms that can provide localized support to the glass substrate bottom edge during vertical sheet transportation. This can be achieved by applying a mechanical support mechanism to the glass edge from the opposing major surfaces along a bottom edge portion of the glass substrate. A length of the guide arms may be equal to or less than the length of the glass substrate in the conveyance direction, and the distance between the guide arms and glass substrate can act as a gap in which the glass is confined and can be adjusted based on the glass thickness, thereby improving the position accuracy and glass stiffness. The gap in which the glass is confined can be fixed, gradual and is assisted by precision positioning actuators. The edge guide will support glass of any thickness, including in a range from about 0.2 millimeters (mm) to about 2.0 mm, for example in a range from about 0.2 mm to about 1.5 mm, for example in a range from about 0.2 mm to about 1 mm. However, embodiments can be particularly beneficial when used for glass substrates comprising a thickness in a range from about 0.2 mm to about 0.7 mm, for example in a range from about 0.2 mm to about 0.5 mm, including all ranges and subranges therebetween.

The edge guide function can be achieved via solid guide arms, guide arms configured as gas bars (e.g., fluid bearings such as air bearings), or a series of rollers, belts, or a combination of these that face the front and back surfaces of the glass edge.

The process sequence for glass substrate bottom edge guidance starts with first and second guide arms in an open position, where a distance between the guide arms is open more than the anticipated lateral movement of the glass substrate, for example a gap between the guide arms equal to or greater than about 200 mm. Sensors detect the glass edge, for example the leading edge relative to the conveyance direction, as the glass edge passes by, which triggers a transport cycle to begin. The sensors may be non-contact sensors, for example optical sensors. For example, two sensors may be used, wherein the first sensor is closer to the overhead gripping mechanisms to ensure position accuracy and the second sensor is near the bottom edge to recognize contact of the glass substrate and the guide arms.

A controller receives a signal from the sensors and instructs a carriage assembly comprising the guide arms to begin moving in a conveyance direction of the glass substrate.

In certain exemplary embodiments, a third sensor can be used to detect the incoming glass edge and signals the controller, whereupon the controller can calculate actual glass substrate speed and update the speed of the carriage assembly to match the top overhead conveyor. The first and third sensors, working in concert, can also be used to detect defects, such as broken edges, and to send a signal to an operator or automatic control in a downstream process to discard glass substrates with break defects.

Extension devices, attached to the carriage assembly, for example pneumatic slides, position the guide arms to constrain lateral movement of the glass substrate bottom edge. The guide arms are positioned at least 10 mm back from the leading edge so the leading edge of the glass substrate is not contacted during the process.

The carriage assembly continues to move until the leading edge is cleared, for example when the leading edge of the glass substrate has been guided through a predetermined part or all of the downstream process. The carriage returns to a start position once the trailing edge of the glass substrate is through part or all of the downstream process. Then, the controller instructs the extension devices to open the guide arms to receive the next oncoming glass substrate.

Accordingly, an apparatus for constraining lateral movement of a glass substrate conveyed in a substantially vertical orientation is also disclosed, the apparatus comprising a conveyance member, a carriage assembly coupled to the conveyance member and movable along a length of the conveyance member in a conveyance direction, the carriage assembly comprising first and second guide arms coupled thereto and extending therefrom in a direction substantially parallel with the conveyance direction, the guide arms movable along a lateral direction orthogonal to the conveyance direction. For example, in some embodiments the first and second guide arms may be coupled to first and second extension devices, respectively, the first and second extension devices coupled to the carriage assembly and arranged to move the first and second guide arms in directions orthogonal to the conveyance direction. A first sensor may be positioned to detect an edge of the glass substrate, for example a leading edge relative to the conveyance direction, at a first position, and a controller that controls and coordinates movement of the carriage assembly and the extension devices. The first sensor may, for example, be positioned to detect the leading edge of the glass substrate at an upper edge portion of the glass substrate, e.g. where the glass substrate is clamped by a clamping device. In further embodiments, the first sensor may be positioned to detect a trailing edge of the glass substrate. The first sensor may comprise an optical sensor, although in further embodiments the first sensor may be a contact sensor that detects an edge of the glass substrate by contacting the edge.

Each guide arm may comprise a plurality of rollers rotatably mounted along a length of the guide arm. Alternatively or in addition, each guide arm may comprise a plurality of gas vents in fluid communication with a source of pressurized gas such that pressurized gas delivered to the guide arms is forced under pressure through vents in the guide arm in a direction toward the glass substrate.

The apparatus may further comprise a second sensor positioned to detect an edge of the glass substrate at a second position downstream of the first position relative to the conveyance direction, for example the leading edge relative to the conveyance direction, although in other embodiments the second sensor may be positioned to detect a trailing edge of the glass substrate. Additionally, the apparatus may still further comprise a third sensor positioned to detect an edge of the glass sheet at a third position, the third sensor vertically aligned with the first sensor. The third sensor can be positioned to detect the leading edge of the glass sheet at a bottom edge portion of the glass substrate although in further embodiments, the first sensor may be positioned to detect a trailing edge of the glass substrate. The second and third sensors may be optical sensors, although in further embodiments the second and third sensors may be contact sensors that detect an edge of the glass substrate by contacting the edge.

The apparatus may comprise a glass drawing apparatus, for example a fusion down draw apparatus, although other glass drawing processes may be used, for example a slot draw apparatus.

In another embodiment, a method of constraining movement of a glass substrate is disclosed comprising conveying a glass substrate in a conveyance direction, the glass substrate supported from a top thereof in a substantially vertical orientation, and sensing a position of an edge of the glass substrate relative to the conveyance direction. The method further comprises using the sensed position of the edge to determine the conveyance speed and moving a carriage assembly in the conveyance direction at the conveyance speed in response to the sensed position of the glass substrate, the carriage assembly comprising a pair of opposing guide arms coupled thereto and extending therefrom in a direction substantially parallel with the conveyance direction. The carriage assembly moves the guide arms in a lateral direction orthogonal to the conveyance direction from an open position to a constraining position, thereby reducing a gap between the guide arms and constraining movement of the glass substrate in the lateral direction. Each opposing guide arm may comprise a plurality of rollers mounted along a length thereof, each roller including a contact surface, and wherein a distance between opposing contact surfaces of the opposing rollers after the moving is less than 200 mm. Each opposing guide arm may comprise a plurality of gas vents arranged along a face of the guide arm, the method further comprising directing a flow of gas from the gas vents in the lateral direction to constrain lateral movement of the glass sheet.

Each guide arm can include a downstream end relative to the conveyance direction, and when the opposing guide arms are in the constraining position, the downstream end of each opposing guide arm is at least 10 mm from the edge of the glass substrate. In some embodiments, the guide arms may contact the glass substrate when the guide arms are in the constraining position.

In some embodiments, sensing a position of the edge may comprise sensing a first position of the edge with a first sensor and sensing a second position of the edge with a second sensor downstream from the first sensor relative to the conveyance direction. In further embodiments, sensing a position of the edge of the glass sheet may comprise sensing a third position of the edge with a third sensor, the third sensor positioned proximate a bottom edge portion of the glass sheet. The third sensor may be vertically aligned with the first sensor.

The method may further comprise comparing an edge signal from the first sensor to an edge signal from the third sensor, and if the edge position from the first sensor is not equal to the edge position from the third sensor, signaling rejection of the glass sheet. The sensed edge may be, for example, the leading edge of the glass substrate, although in further embodiments, the sensed edge may be the trailing edge.

A thickness of the glass substrate can be equal to or less than 2 millimeters, for example in a range from about 0.2 mm to about 2 mm, for example in a range from about 0.2 mm to about 1 mm, in range from about 0.2 to about 0.7 mm, or in a range from about 0.2 mm to about 0.5 mm, including all ranges and subranges therebetween.

Additional features and advantages of the embodiments disclosed herein will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments intended to provide an overview or framework for understanding the nature and character of the embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a perspective view of an fusion glass making processes including a substrate conveyance apparatus according to an embodiment disclosed here;

FIG. 2 is a perspective view of an exemplary glass substrate conveyance apparatus;

FIG. 3 is an isometric top view of the conveyance apparatus of FIG. 2;

FIG. 4 is a perspective view of a portion of the glass substrate conveyance apparatus of FIG. 2 showing rollers rotatably attached to guide arms;

FIG. 5 is a perspective view of a portion of the glass substrate conveyance apparatus of FIG. 2 showing guide arms comprising gas vents;

FIG. 6 is a perspective view of the glass substrate conveyance apparatus of FIG. 2 showing sensors for detecting the glass substrate, or a portion thereof;

FIG. 7 is a perspective view of a portion of the glass conveyance apparatus of FIG. 2 showing guide arms as they are moving forward in a conveyance direction, and closed against the glass substrate therebetween; and

FIG. 8 is a perspective view of a portion of the glass conveyance apparatus of FIG. 2 showing guide arms as they are moving forward in a conveyance direction and entered into a downstream process station, the guide arms closed against the glass substrate therebetween.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein - for example up, down, right, left, front, back, top, bottom - are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

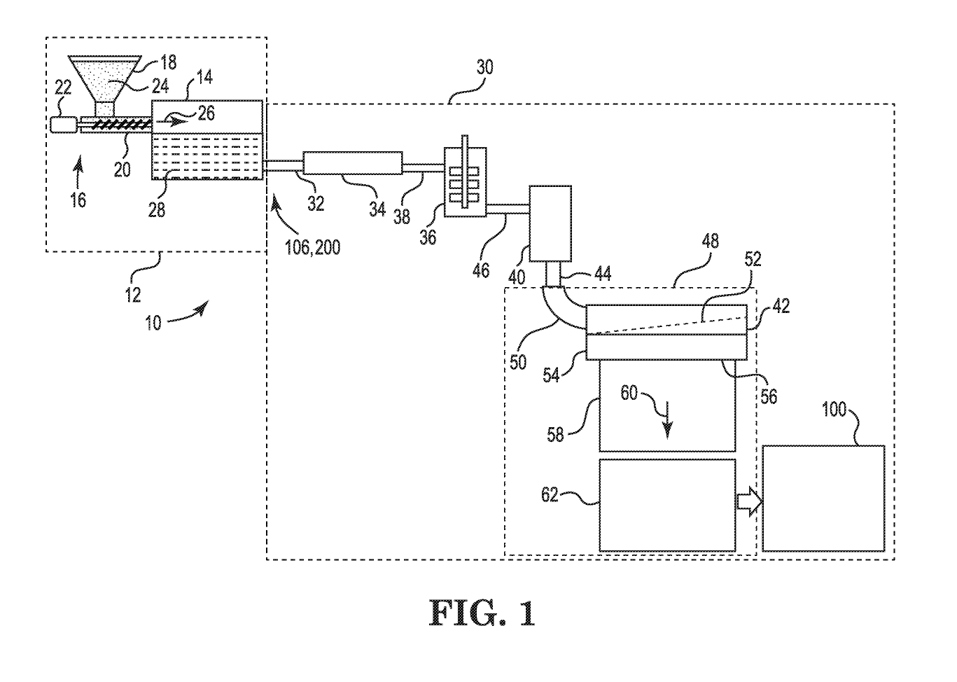

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) arranged to reduce heat loss from a vicinity of the melting vessel. In still further examples, glass melting furnace 12 may include electronic devices and/or electromechanical devices that facilitate melting the raw materials into a glass melt. Still further, glass melting furnace 12 may include support structures (e.g., support chassis, conveyance member, etc.) or other components.

Glass melting vessel 14 is typically comprised of refractory material, such as a refractory ceramic material, for example a refractory ceramic material comprising alumina or zirconia. In some examples, glass melting vessel 14 may be constructed from refractory ceramic bricks.

In various embodiments, the glass melting furnace may be incorporated as a component of a glass manufacturing apparatus configured to fabricate a glass substrate, for example a glass ribbon of a continuous length. In some examples, the glass melting furnace may be incorporated as a component of a glass manufacturing apparatus comprising a slot draw apparatus, a float bath apparatus, a down draw apparatus (for example a fusion down draw apparatus), an up draw apparatus, a press rolling apparatus, a tube drawing apparatus or any other glass manufacturing apparatus that would benefit from the embodiments disclosed herein. By way of example, FIG. 1 schematically illustrates glass melting furnace 12 as a component of a fusion down draw glass manufacturing apparatus 10 for fusion drawing a glass ribbon for subsequent processing into individual glass sheets (substrates).

The glass manufacturing apparatus 10 (e.g., fusion down draw apparatus 10) can optionally include an upstream glass manufacturing apparatus 16 positioned upstream relative to glass melting vessel 14. In some embodiments, a portion of, or the entire upstream glass manufacturing apparatus 16, may be incorporated as part of the glass melting furnace 12.

As shown in the illustrated example, upstream glass manufacturing apparatus 16 can include a storage bin 18, a raw material delivery device 20 and a motor 22 connected to the raw material delivery device. Storage bin 18 may store a quantity of raw material 24 that can be fed into melting vessel 14 of glass melting furnace 12, as indicated by arrow 26. Raw material 24 typically comprises one or more glass forming metal oxides and one or more modifying agents. In some embodiments, raw material delivery device 20 can be powered by motor 22 such that raw material delivery device 20 delivers a predetermined amount of raw material 24 from the storage bin 18 to melting vessel 14. In further examples, motor 22 can power raw material delivery device 20 to introduce raw material 24 at a controlled rate based on a level of molten glass sensed downstream from melting vessel 14. Raw material 24 within melting vessel 14 can thereafter be heated to form molten glass 28.

Glass manufacturing apparatus 10 can also optionally include a downstream glass manufacturing apparatus 30 positioned downstream of glass melting furnace 12. In some embodiments, a portion of downstream glass manufacturing apparatus 30 may be incorporated as part of glass melting furnace 12. However, in some instances, first connecting conduit 32 discussed below, or other portions of the downstream glass manufacturing apparatus 30, may be incorporated as part of the glass melting furnace 12. Elements of downstream glass manufacturing apparatus 30, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, rhenium, tantalum, titanium, tungsten and alloys thereof

The downstream glass manufacturing apparatus 30 can include a first conditioning (i.e. processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may drive molten glass 28 through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Within fining vessel 34, bubbles may be removed from molten glass 28 by various techniques. For example, raw material 24 may include multivalent compounds (i.e., fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the fining agent. Oxygen bubbles produced by the temperature-induced chemical reduction of the fining agent(s) rise through the molten glass within the fining vessel, wherein gases in the molten glass produced in the melting furnace can coalesce into the oxygen bubbles produced by the fining agent. The enlarged gas bubbles can then rise to a free surface of the molten glass in the fining vessel and thereafter be vented out. The oxygen bubbles can further induce mechanical mixing of the molten glass in the fining vessel.

Downstream glass manufacturing apparatus 30 can further include another conditioning vessel such as a mixing apparatus 36 for mixing the molten glass. Mixing apparatus 36 can be located downstream from the fining vessel 34. The glass melt mixing apparatus 36 can be used to provide a homogenous molten glass composition, thereby reducing cords of chemical or thermal inhomogeneity that may otherwise exist within the fined molten glass exiting the fining vessel. As shown, fining vessel 34 may be coupled to molten glass mixing apparatus 36 by way of a second connecting conduit 38. In some examples, molten glass 28 may be gravity fed from the fining vessel 34 to mixing apparatus 36 by way of second connecting conduit 38. For instance, gravity may drive molten glass 28 through an interior pathway of second connecting conduit 38 from fining vessel 34 to mixing apparatus 36. It should be noted that while mixing apparatus 36 is shown downstream of fining vessel 34, mixing apparatus 36 may be positioned upstream from fining vessel 34. In some embodiments, downstream glass manufacturing apparatus 30 may include multiple mixing apparatus, for example a mixing apparatus upstream from fining vessel 34 and a mixing apparatus downstream from fining vessel 34. These multiple mixing apparatus may be of the same design, or they may be of a different design from one another.

Downstream glass manufacturing apparatus 30 can further include another conditioning vessel such as delivery vessel 40 that may be located downstream from mixing apparatus 36. Delivery vessel 40 may condition molten glass 28 to be fed into a downstream forming device. For instance, delivery vessel 40 can act as an accumulator and/or flow controller to adjust and provide a consistent flow of molten glass 28 to forming body 42 by way of exit conduit 44. As shown, mixing apparatus 36 may be coupled to delivery vessel 40 by way of third connecting conduit 46. In some examples, molten glass 28 may be gravity fed from mixing apparatus 36 to delivery vessel 40 by way of third connecting conduit 46. For instance, gravity may drive molten glass 28 through an interior pathway of third connecting conduit 46 from mixing apparatus 36 to delivery vessel 40.

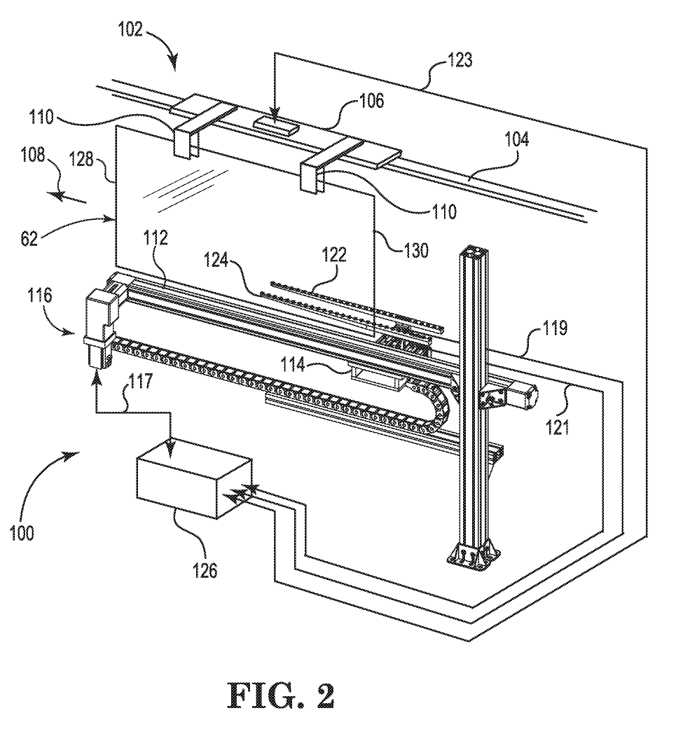

Downstream glass manufacturing apparatus 30 can further include forming apparatus 48 comprising the above-referenced forming body 42 and including inlet conduit 50. Exit conduit 44 can be positioned to deliver molten glass 28 from delivery vessel 40 to inlet conduit 50 of forming apparatus 48. As best seen with the aid of FIG. 2, forming body 42 in the illustrated fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows the walls of the trough and descends downward along converging forming surfaces 54 as separate flows of molten glass. The separate flows of molten glass join below and along the bottom edge 56 to produce a single ribbon of glass 58 that is drawn in draw direction 60 from bottom edge 56 by applying tension to the glass ribbon, such as by gravity, edge rolls and pulling rolls (not shown), to control the dimensions of the glass ribbon as the glass cools and a viscosity of the glass increases. As glass ribbon 58 cools and goes through a visco-elastic transition, the glass ribbon acquires mechanical properties that give the glass ribbon 58 stable dimensional characteristics. Glass ribbon 58 may, in some embodiments, be separated into individual glass substrates 62 by a glass separation apparatus (not shown) in an elastic region of the glass ribbon by either mechanical or laser scoring techniques. These glass sheets are typically then transported via a conveyance mechanism, for example a vertical conveyance mechanism, using a gripping mechanism that holds the top edge of the glass substrate, with the glass substrate hanging vertically downward during this transport. The glass is then moved via this conveyance to subsequent process steps such as edge trimming, referred to as bead removal, quality measurements for thickness, surface defects, inclusions and later packing. A common method to guide the glass bottom into these devices is via fixed rollers, metal guides or wire guides at the various downstream process equipment stations.

It has been discovered that when the glass substrate comes into contact with these fixed position guides chipping of the sharp leading edge is possible, which in turn can lead to substrate breakage. Scratches due to relative motion between the fixed guide and the moving glass substrate have also been observed.

In addition to a trend toward thinner glass substrates that are more susceptible to buckling, thin glass substrates are even more susceptible to impact damage when the edges are “as-cut” and without the benefit of a beveling or rounding process step. These “square” cut edges can easily chip and then break. Having a guidance system that does not contact this as-cut edge can reduce the breakage potential.

For display applications, there is also a trend toward higher resolution, i.e., smaller pixel sizes and/or pixel density, requiring glass surface cleanliness to be even better than prior requirements. Fixed guides can cause scratches and/or chips that may lead to glass particles that can adhere to the glass sheet surface. These adhered glass particles can become defects to the final product. Accordingly, apparatus and methods that can reduce glass particle generation within LCD manufacturing processes are highly desirable.

Profitability in the LCD glass industry has often relied on faster processing speeds, desirably with improved glass output and without an increase in capital, by using higher melting flow rates. Combining increased flow of molten glass with thinner glass sheets means more glass sheets per unit time, but which further depends on increased conveyance speeds. An increase in conveyance speed, coupled with thinner glass, can cause more sway of the glass bottom edge portion when using only top edge support and transport. That is, the thin glass substrates tend to swing from side to side (laterally) more easily. Increased lateral movement of the glass sheet makes guidance of the glass into downstream process equipment using fixed guidance devices more difficult, as such lateral movement may cause the leading edge of the glass substrate to collide with downstream process equipment or even with the guidance device itself

Described herein are apparatus and methods that can facilitate increased transport speeds while providing a natural progression from a vertical forming process, for example a fusion down draw process, into downstream processing equipment. It should be understood, however, that the apparatus and methods described herein may be beneficial to other glass forming processes as well, including but not limited to slot draw and float methods of forming glass sheets.

FIG. 2 illustrates an exemplary conveyance apparatus 100 comprising a transport assembly 102 that moves glass substrates from one processing station to another processing station, for example from a draw process station to an inspection process station, or any other process station that may be employed in a glass manufacturing process. Transport assembly 102 comprises a rail or track 104, for example an overhead rail system, and a movable mounting assembly 106, wherein movable mounting assembly 106 is designed to travel along rail 104 in a conveyance direction 108. Mounting assembly 106 comprises clamping devices 110 that attach, for example clamp, to glass substrate 62 wherein transport assembly 102 can transport glass substrate 62 to a downstream destination, for example a downstream glass processing station. Mounting assembly 106 may be driven by any suitable means, including linear motors, chain or pulley drives and so forth. Mounting assembly 106 may be controlled by a controller, described more fully below. Mounting assembly 106 may be moved at a constant speed, or mounting assembly 106 may be moved at a variable speed. For example, in some embodiments it may be necessary to slow or stop mounting assembly 106, and therefore the glass substrate being transported, so that processing of the glass substrate 62 at a given downstream process station may be accomplished, although in most embodiments, mounting assembly 106 is moved continuously along rail 104.

Conveyance apparatus 100 further comprises a conveyance member 112 including a carriage assembly 114 movable along a length of conveyance member 112 in conveyance direction 108. For example, carriage assembly 114 may be coupled to a drive assembly 116, for example a linear motor, a servo motor or any other drive device suitable to convey carriage assembly 114 along a length of conveyance member 112 in the conveyance direction and in a return direction opposite the conveyance direction. Conveyance member 112 may comprise, for example, a track, a rail or any other suitable guidance mechanism capable of supporting and guiding movement of carriage assembly 114 in the conveyance and return directions.

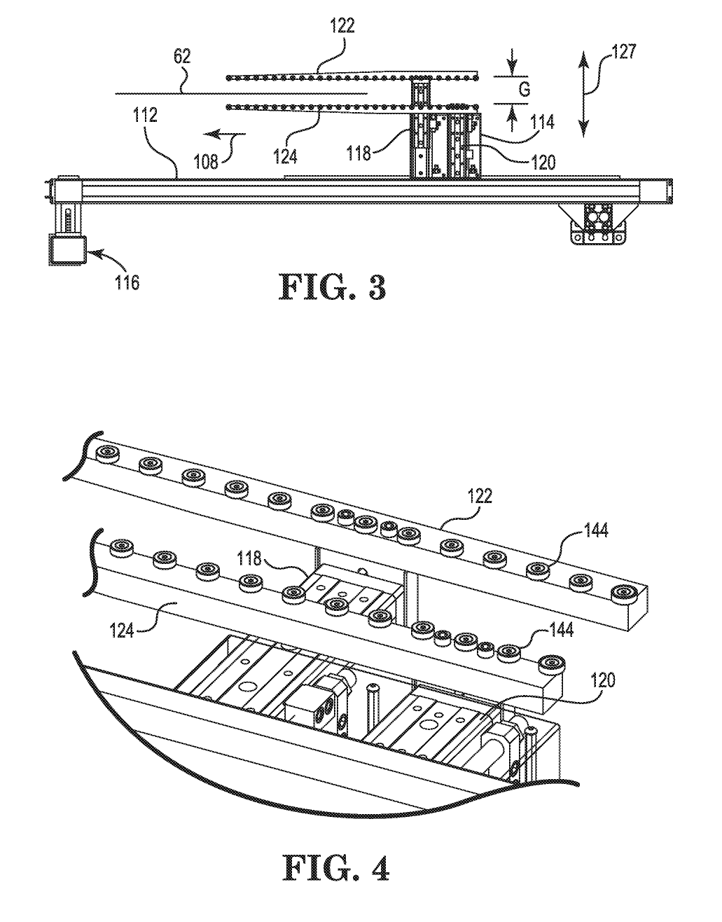

Referring now to FIGS. 3 and 4, carriage assembly 114 comprises first extension device 118 and second extension device 120, each extension device coupled to carriage assembly 114 and comprising a first guide arm 122 and a second guide arm 124, respectively, extending therefrom and arranged in an opposing relationship with the other guide arm, for example in a direction substantially parallel with conveyance direction 108. In some embodiments, extension devices 118, 120 can be pneumatic slides that extend or retract first and second guide arms 122, 124 along lateral direction 127 orthogonal to conveyance direction 108, i.e., either toward or away from conveyance member 112. In further embodiments, first and second extension devices 118, 120 may be servo motors. In the embodiment depicted in FIGS. 3 and 4, first extension device 118 is positioned such that when the first extension device 118 extends, first guide arm 122 (which is the “outside” guide arm in the figures) is moved away from conveyance member 112, and when first extension device 118 retracts, first guide arm 122 moves toward conveyance member 112. Similarly, second extension device 120 is positioned such that when the extension device extends, second guide arm 124 (which is the “inside” guide arm in the figures, closest to conveyance member 112) is moved away from conveyance member 112, and when second extension device 120 retracts, second guide arm 124 moves toward conveyance member 112. First and second extension devices 118, 120 can be used in opposition to each other such that when one extension device extends, the other extension device retracts, therefore causing first and second guide arms 122, 124 to perform an opening or closing operation. For example, if first extension device 118 extends and second extension device 120 retracts, guide arms 122, 124 will perform an opening operation and a gap G therebetween will increase. Conversely, if first extension device 118 retracts and second extension device 120 extends, guide arms 122, 124 will perform a closing operation and gap G will decrease.

Conveyance apparatus 100 further comprises a controller 126 that controls and coordinates movement of carriage assembly 114 and guide arms 122, 124 by controlling drive assembly 116 through control line 117 and extension devices 118, 120 through control lines 119, 121, respectively. Controller 126 may further control the movement of mounting assembly 106, for example through control line 123, although in further embodiments mounting assembly 106 may be controlled by a second separate controller. As used herein, the term “controller” or “processor” can encompass all apparatus, devices, and machines for processing data and optionally operating such machines, and including by way of embodiment a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of these.

Embodiments and the functional operations described herein can be implemented in digital electronic circuitry, or in computer software, firmware, or hardware, including the structures disclosed in this specification and their structural equivalents, or in combinations of one or more of them. Embodiments described herein can incorporate one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine readable storage substrate, a memory device, or a combination of one or more of these.

A computer program (also known as a program, software, software application, script, or code) can be written in any form of programming language, including compiled or interpreted languages, or declarative or procedural languages, and a computer program can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described herein can be performed using one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit) to name a few.

Processors suitable for the execution of a computer program include, by way of embodiment, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of data memory including nonvolatile memory, media and memory devices, including by way of embodiment semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments described herein can be implemented on a computer having a display device, e.g., an LCD (liquid crystal display) monitor, and the like for displaying information to the user, and a keyboard and a pointing device, e.g., a mouse or a trackball, or a touch screen by which the user can provide input to the computer. Other devices can be used to provide for interaction with a user as well; for example, input from the user can be received in any form, including acoustic, speech, or tactile input.

Embodiments described herein can include a computing system that includes a back end component, e.g., as a data server, or that includes a middleware component, e.g., an application server, or that includes a front end component, e.g., a client computer having a graphical user interface or a Web browser through which a user can interact with an implementation of the subject matter described herein, or any combination of one or more such back end, middleware, or front end components. The components of the system can be interconnected by any form or medium of digital data communication, e.g., a communication network. Embodiments of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other

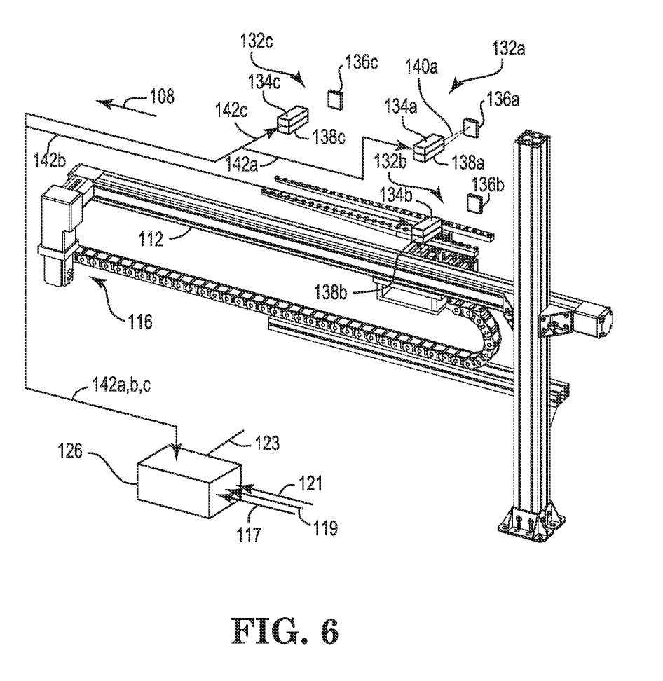

Controller 126 may control movement of carriage assembly 114 and extension devices 118, 120 via pre-programmed instructions contained in or on computer readable media and executed by the controller. In other embodiments, controller 126 may control movement of carriage assembly 114 and extension devices 118, 120 in response to external inputs, for example sensor inputs. In still other embodiments, controller 126 may control movement of carriage assembly 114 and extension devices 118, 120 in response to both pre-programmed instructions and sensor input. For example, conveyance apparatus 100 may include sensors that detect a position of the glass substrate or a portion thereof, including any one or all of a leading edge 128 and/or a trailing edge 130 of the glass substrate relative to conveyance direction 108, for example a top portion of the leading edge, a bottom portion of the leading edge, a top portion of the trailing edge and/or a bottom portion of the trailing edge. To that end, conveyance apparatus 100 may include first sensor 132a (see FIG. 6) positioned to detect an edge 128 of glass substrate 62 relative to conveyance direction 108. For example, first sensor 132a may be positioned to detect a leading edge 128 of glass substrate 62 relative to conveyance direction 108. However, in further embodiments, first sensor 132a may be positioned to detect a trailing edge 130 of glass substrate 62 relative to conveyance direction 108. First sensor 132a may be a non-contact sensor, for example an optical sensor, although in further embodiments first sensor 132a may be a contact-style sensor. First sensor 132a may include light source 134a, reflective target 136a and detector 138a. Light source 134a may be, for example, a laser or a focused light emitting diode (LED). First sensor 132a can be positioned upstream of a start position for carriage assembly 114, as discussed in more detail below, wherein light source 134a and detector 138a are positioned on one side of the conveyance path, and reflective target 136a is positioned on the opposite side of the conveyance path. Light beam 140a from light source 134a, for example a laser beam, is projected across the conveyance path of substrate 62 and reflected by reflective target 136a. The reflected light is then received by detector 138a, wherein the presence or absence of the glass sheet, e.g., leading edge 128, is communicated to controller 126 via an appropriate signal over data line 142a. The presence of the glass substrate as detected by detector 138a causes controller 126 to being the guiding cycle.

Each guide arm 122, 124 is positioned to restrain movement of a nominally vertical glass substrate positioned between the guide arms. For example, in some embodiments, each guide arm 122, 124 may comprise a plurality of rollers 144 (see FIG. 4) arrayed and rotatably mounted along a length of the each guide arm such that when the guide arms are moved in opposite directions along lateral direction 127 so that gap G between the guide arms is reduced, glass substrate 62 may contact the rollers. For example, depending on the width of gap G between the opposing guide members, glass substrate 62 may contact the rollers only sporadically, when lateral movement of the glass substrate is sufficiently great, thereby limiting movement of the glass substrate bottom edge to be within gap G. In other embodiments, guide arm 122, 124 may be positioned such that they contact the bottom edge portion of the glass substrate during the time glass substrate 62 is positioned between the guide arms and thus rollers 144 are in continuous contact with the glass substrate.

In further embodiments, non-contact restraint may be employed, wherein guide arms 122, 124 may each comprise a plurality of gas vents 146. A pressurized gas supplied to the guide arms via gas supply lines 148, 150 may then be forced through the gas vents of the opposing guide arms, thereby restraining lateral movement of the glass sheet. In some embodiments, the pressurized gas may be air, although in further embodiments the gas may be a different gas.

Methods of operating conveyance apparatus 100 and the guiding cycle will now be discussed. Referring to FIGS. 2 and 6, in one embodiment, as transport assembly 102 moves glass substrate 62 along rail 104, light source 134a from first sensor 132a is projecting light beam 140a that reflects from reflective target 136a and is received by detector 138a, in response to which detector 138a indicates to controller 126 with a suitable electrical signal that the conveyance path is clear (i.e., there is an absence of a glass substrate in that portion of the conveyance path illuminated by the light source as received by the detector). Carriage assembly 114 is in its initial start position (e.g., to the right end of conveyance member 112 in FIGS. 2 and 6), and guide arms 122, 124 are in an open position, for example wherein gap G is greater than 200 mm. As glass substrate 62 continues to move in conveyance direction 108, leading edge 128 of glass substrate 62 intersects light beam 140a, at which point detector 138a fails to receive reflected light from reflective target 136a, or receives insufficient light. Accordingly, detector 138a registers the presence of the glass substrate by the absence of light or receiving insufficient light and sends an appropriate signal to controller 126. In response, controller 126 instructs drive assembly 116 to begin moving carriage assembly 114 in conveyance direction 108.

In some embodiments, conveyance apparatus 100 may further comprise a second sensor 132b positioned below first sensor 132a, second sensor 132b comprising similar components as first sensor 132a with similar functions. For example, second sensor 132b may comprise a light source 134b (e.g., a focused LED or a laser), reflective target 136b and detector 138b positioned to receive light from light source 134b reflected from reflective target 136b. Second sensor 132b may be positioned to detect leading edge 128 simultaneously with first sensor 132a. That is, for a rectangular cut glass substrate, and assuming proper alignment of the top edge of the glass substrate in clamping devices 110, leading edge 128 should present a vertical line. Consequently, leading edge 128 should “break” the light beams from both the first and second sensor assemblies 132a,b simultaneously. If controller 126 receives signals indicating that simultaneous detection of leading edge 128 was not obtained, then a possible cause could be the glass substrate is broken. The controller may then initiate additional actions, including but not limited to stopping or slowing conveyance apparatus 100 so that glass substrate 62 may be removed, or, conveyance apparatus 100 continues conveying glass substrate 62 but controller 126 registers the position of the glass substrate (relative to other glass substrates that may be conveyed) so that a downstream action can be later taken, for example additional inspection by a human operator. If, on the other hand, simultaneous detection of the leading edge is obtained, the conveyance apparatus (e.g., controller 126) may proceed to move the glass substrate in the conveyance direction without additional action as triggered by a defective glass substrate.

Detection of leading edge 128 can be used by controller 126 to begin movement of carriage assembly 114 in conveyance direction 108. In some embodiments, the speed of glass substrate 62 in the conveyance direction may be obtained by controller 126 directly from mounting assembly 106 or from the driving apparatus for mounting assembly 106 (not shown). For example, mounting assembly 106, or the driving apparatus, may include an encoder for tracking progress of the mounting assembly along rail 104, including a speed of the mounting assembly along the rail. However, in other embodiments, conveyance apparatus 100 may include a third sensor 132c positioned downstream from first sensor 132a. Similar to first and second sensors 132a, 132b, third sensor 132c may include light source 134c (for example a focused LED or a laser), reflective target 136c and detector 138c and may operate in the same manner as first and second sensors 132a, 132b. Controller 126 can calculate the time between the “glass present” signal from first sensor 132a and the “glass present” signal from third sensor 132c and, for a given glass substrate size pre-programmed into the controller, a speed of the glass substrate in the conveyance direction can be calculated. Thus, once controller 126 has calculated the conveyance speed of the glass substrate, controller 126 can match the speed of carriage assembly 114 to the speed of glass substrate 62. Controller 126 may also signal extension devices 118, 120 to begin closing, thereby reducing gap G. It should be noted that the preceding description utilized the passing of leading edge 128 for determining the presence or absence of the glass substrate in the sensor detection path and for calculating a speed of the glass substrate as conveyed by the mounting assembly. However, similar information can be obtained by detecting the trailing edge.

As previously noted, guide arms 122, 124 may reduce gap G without employing continuous contact with glass substrate 62, thereby forming a lateral movement envelope defined by gap G for the bottom edge of the glass substrate between portions of the guide arms. That is, gap G may be reduced to a value less than the fully open gap size, but large enough so that the bottom edge of glass substrate is allowed some small amount of lateral movement. For example, gap G may be reduced to a gap size in a range from about 10 mm to about 100 mm, for example in a range from about 20 mm to about 90 mm. As previously described, guide arms 122, 124 may comprise rollers 144, the rollers providing a contact surface against which glass substrate 62 my come in contact with. Rollers 144 ensure any relative motion between the glass substrate and the guide arms is accommodated by the rollers rolling against the major surfaces of the glass substrate rather than producing a sliding motion between the guide arms and the glass substrate that could mark or damage the surfaces of the glass substrate. However, in other embodiments, gap G may be reduced until guide arms 122, 124 are in continuous contact with glass substrate 62, thereby gripping glass substrate between the opposing guide arms. Whether guide arms 122, 124 are in continuous contact or only intermittent contact may be dictated by the nature of the downstream process. For example, continuous contact may be required for very precise positioning of the leading edge as the leading edge enters the downstream process. Moreover, continuous contact between the glass substrate bottom edge portion and the guide arms can be used to flatten the glass substrate should the glass substrate exhibit curvature (“bow”) that may prove problematic when entering the downstream process. For example, curvature may make damaging contact between the leading edge of the glass substrate and downstream processing equipment more likely and is therefore to be avoided.

In still other embodiments, each guide arm may be fitted with one or more endless belts (not shown), wherein the belts function in a similar manner as rollers 144.

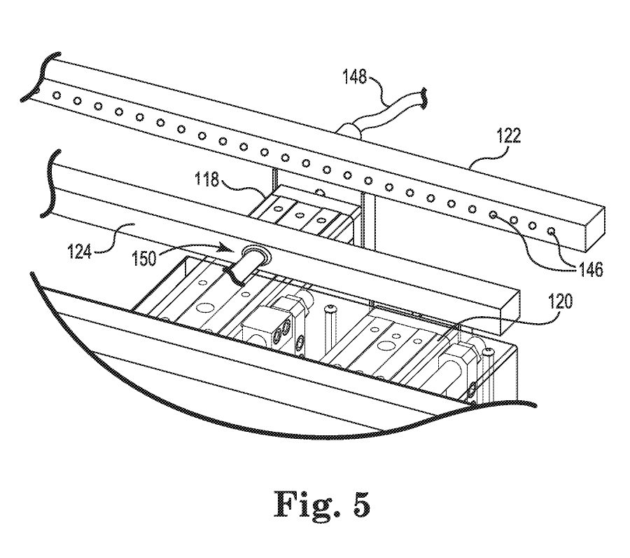

In other embodiments, as illustrated in FIG. 5, guide arms 122, 124 may use air pressure to force the glass substrate into a predetermined envelope between the guide arms. For example, guide arms 122, 124 may receive pressurized gas from a source of pressurized gas (not shown) through gas supply lines 148, 150, respectively. Each guide arm may include an internal plenum or gas space, and a plurality of gas vents 146 in a face of each guide arm that opposes the glass substrate. Pressurized gas can then be received by the guide arms, forced from the gas vents and directed to the major surfaces of the glass substrate. The gas pressure can be balanced between the two guide arms so the glass substrate is positioned in a desired location between the guide arms, such as in or near the middle of gap G. In addition or alternatively, the faces of the guide arms opposed to the glass substrate major surfaces may comprise a porous material including a multitude of passages, for example carbon, densely perforated polymer or metal, a sintered material or any other porous material suitable for ejecting air at glass substrate 62 and maintaining a position of glass substrate 62 within gap G.

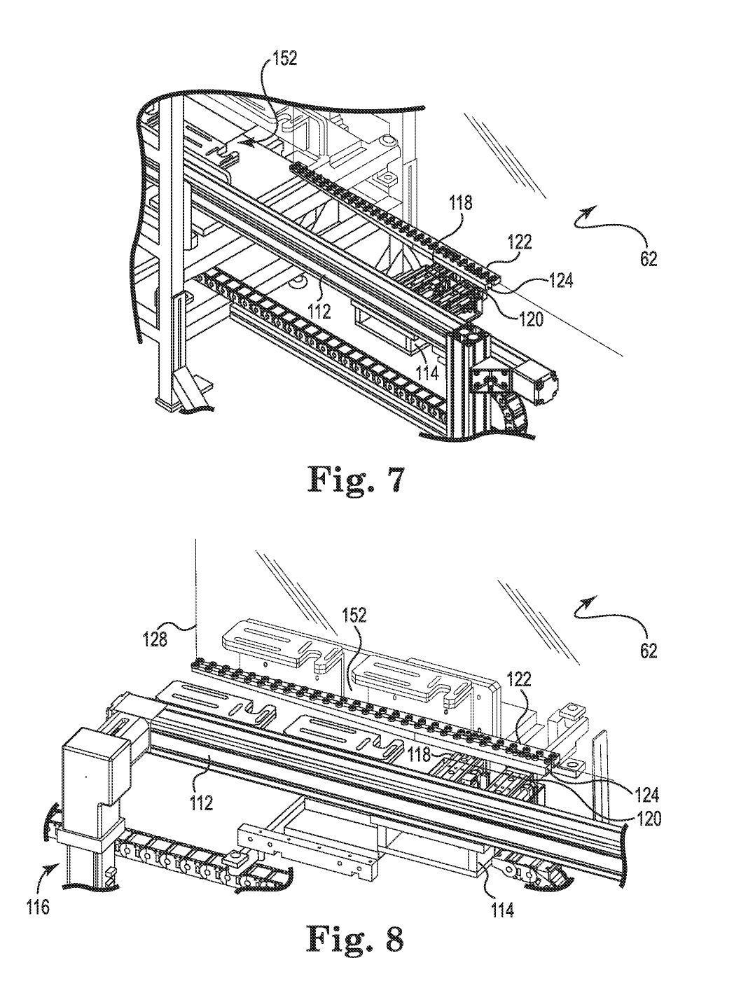

FIG. 7 is a perspective view of a portion of glass substrate conveying apparatus illustrating guide arms 122, 124 is a closed position continuously contacting glass substrate 62 along a bottom edge portion thereof, with carriage assembly 114 moving forward in the conveyance direction at the conveyance speed of the glass substrate as the glass substrate is moving toward process station 152.

It should be understood that, since leading edge 128 may be more vulnerable to breakage from contact than other portions of the glass substrate, it is desirable that guide arms 122, 124 do not contact the glass substrate at leading edge 128 even if the guide arms are in continuous contact with the glass substrate. Thus, controller 126 may be programmed such that the extreme downstream ends of the guide arms (leading tips of the guide arms) are positioned upstream from the leading edge relative to the conveyance direction when the guide arms have reached a final guiding position (e.g., when gap G is no longer being reduced). That is, the ends of the guide arms should be positioned back from the leading edge of the glass substrate. For example, controller 126 can be programed to drive carriage assembly 114 to position guide arms 122, 124 such that the leading tips of the guide arms are upstream of the leading edge by at least 10 mm, for example in a range from about 10 mm to about 100 mm, for example in a range from about 10 mm to about 60 mm, including all ranges and subranges therebetween.

FIG. 8 is a perspective view of a portion of glass substrate conveying apparatus 100 with glass substrate 62 still in continuous contact with guide arms 122, 124, but wherein leading edge 128 has passed well into the downstream processing area 152. Once glass substrate 62 has been transferred to the downstream process station and leading edge 128 has cleared potentially damaging aspects of the downstream process equipment, controller 126 can instruct extension devices 118, 120 to open gap G between guide arms 122, 124 by extending guide arm 122 in the lateral dimension and retracting guide arm 124 in the lateral dimension. Additionally, controller 126 can direct drive assembly 116 to move carriage assembly 114 in a return direction opposite conveyance direction 108 until carriage assembly 114 is returned to the start position to await the next glass substrate, whereupon the process cycle as described supra repeats.

It should be apparent that downstream glass manufacturing apparatus 30 may comprise a plurality of glass substrate conveying apparatus 100 located in various portions of the downstream glass manufacturing apparatus. In some embodiments, several glass substrate conveying apparatus 100 may be sequentially positioned such that one glass substrate conveying apparatus 100 may hand off guiding of a glass substrate to a subsequent downstream conveying apparatus 100.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

What is claimed is:

1. An apparatus for constraining lateral movement of a glass substrate conveyed in a substantially vertical orientation, comprising:
a conveyance member;
a carriage assembly coupled to the conveyance member and movable along a length of the conveyance member in a conveyance direction, the carriage assembly including first and second guide arms extending therefrom in a direction substantially parallel with the conveyance direction, the guide arms movable along a lateral direction orthogonal to the conveyance direction;
a first sensor positioned to detect a leading edge of the glass substrate at a first position; and
a controller configured to control and coordinate movement of the carriage assembly and the pair of extension devices.

2. The apparatus according to claim 1, wherein the carriage assembly further comprises first and second extension devices, the first and second guide arms coupled to the first and second extension devices, respectively.

3. The apparatus according to claim 1, wherein each guide arm comprises a plurality of rollers rotatably mounted along a length of the guide arm.

4. The apparatus according to claim 1, wherein each guide arm comprises a plurality of gas vents in fluid communication with a source of pressurized gas.

5. The apparatus according to claim 1, wherein the first sensor comprises an optical sensor.

6. The apparatus according to claim 1, further comprising a second sensor positioned to detect a leading edge of the glass sheet at a second position downstream of the first position relative to the conveyance direction.

7. The apparatus according to claim 6, further comprising a third sensor positioned to detect the leading edge of the glass sheet at a third position, the third sensor vertically aligned with the first sensor.

8. The apparatus according to claim 7, wherein the third sensor is positioned to detect the leading edge of the glass sheet at a bottom edge portion of the glass substrate.

9. The apparatus according to claim 1, wherein the first sensor is positioned to detect the leading edge of the glass sheet at a top edge portion of the glass substrate.

10. The apparatus according to claim 1, wherein the conveyance apparatus comprises a glass drawing apparatus.

11. An apparatus for constraining lateral movement of a glass substrate conveyed in a substantially vertical orientation comprising:
a conveyance member;
a carriage assembly coupled to the conveyance member and movable along a length of the conveyance member in a conveyance direction;
a first extension device and a second extension device, the first and second extension devices coupled to the carriage assembly, each extension device including a guide arm extending therefrom in a direction substantially parallel with the conveyance direction, the guide arms movable along a lateral direction orthogonal to the conveyance direction;
a first sensor positioned to detect a leading edge of the glass substrate at a first position; and
a controller configured to control and coordinate movement of the carriage assembly and the pair of extension devices.

12. The apparatus according to claim 11, wherein each guide arm comprises a plurality of rollers rotatably mounted along a length of the guide arm.

13. The apparatus according to claim 11, wherein each guide arm comprises a plurality of gas vents in fluid communication with a source of pressurized gas.

14. The apparatus according to claim 11, wherein the first sensor comprises an optical sensor.

15. The apparatus according to claim 11, further comprising a second sensor positioned to detect a leading edge of the glass sheet at a second position downstream of the first position relative to the conveyance direction.

16. The apparatus according to claim 15, further comprising a third sensor positioned to detect the leading edge of the glass sheet at a third position, the third sensor vertically aligned with the first sensor.

17. The apparatus according to claim 16, wherein the third sensor is positioned to detect the leading edge of the glass sheet at a bottom edge portion of the glass substrate.

18. The apparatus according to claim 11, wherein the first sensor is positioned to detect the leading edge of the glass sheet at a top edge portion of the glass substrate.

19. The apparatus according to claim 11, wherein the conveyance apparatus comprises a glass drawing apparatus.

20. A method of constraining movement of a glass substrate comprising:
conveying a glass substrate in a conveyance direction, the glass substrate supported from a top thereof in a substantially vertical orientation;
sensing a position of an edge of the glass substrate relative to the conveyance direction;
using the sensed position of the edge to determine a conveyance speed of the glass substrate;
moving a carriage assembly in the conveyance direction at the conveyance speed in response to the sensed position of the glass substrate, the carriage assembly comprising a pair of opposing guide arms coupled thereto and extending therefrom in a direction substantially parallel with the conveyance direction;
moving the guide arms in a lateral direction orthogonal to the conveyance direction from an open position to a constraining position, thereby reducing a gap between the guide arms and constraining movement of the glass substrate in the lateral direction.

21. The method according to claim 20, wherein each opposing guide arm comprises a plurality of rollers mounted along a length thereof, each roller including a contact surface, and wherein a distance between opposing contact surfaces of the opposing rollers after the moving is less than 200 mm.

22. The method according to claim 20, wherein each opposing guide arm comprises a plurality of gas vents arranged along a face of the guide arm, the method further comprising directing a flow of gas from the gas vents in the lateral direction to constrain lateral movement of the glass substrate.

23. The method according to claim 20, wherein each guide arm comprises a downstream end relative to the conveyance direction and the sensed edge is a leading edge of the glass substrate, and when the opposing guide arms are in the constraining position, the downstream end of each opposing guide arm is at least 10 millimeters from the edge of the glass substrate.

24. The method according to claim 20, wherein the guide arms contact the glass substrate in the constraining position.

25. The method according to claim 20, wherein sensing a position of the edge comprises sensing a first position of the edge with a first sensor and sensing a second position of the edge with a second sensor downstream from the first sensor relative to the conveyance direction.

26. The method according to claim 25, wherein sensing a position of the edge of the glass substrate comprises sensing a third position of the edge with a third sensor, the third sensor positioned proximate a bottom edge portion of the glass substrate.

27. The method according to claim 26, wherein the third sensor is vertically aligned with the first sensor.

28. The method according to claim 26, further comprising comparing an edge signal from the first sensor to an edge signal from the third sensor, and if the edge position from the first sensor is not equal to the edge position from the third sensor, rejecting the glass substrate.

29. The method according to claim 20, wherein the sensed edge is the leading edge of the glass substrate.

30. The method according to claim 20, wherein a thickness of the glass substrate is equal to or less than 2 millimeters.
